(19) United States
(12) Patent Application Publication
(10) Pub. No.: US 2018/0267907 A1
(43) Pub. Date: Sep. 20, 2018

(54) METHODS AND APPARATUS FOR COMMUNICATION BETWEEN MOBILE DEVICES AND ACCESSORY DEVICES

(71) Applicant: SLING MEDIA PVT LTD, Bangalore (IN)

(72) Inventors: YUDHISTHIRA ATTRY, Bangalore (IN); AJAY DAVANAM, Bangalore (IN); YATISH JAYANT NAIK RAIKAR, Bangalore (IN); SOHAM SAHABHAUMIK, Bangalore (IN)

(73) Assignee: SLING MEDIA PVT LTD, Bangalore (IN)

(21) Appl. No.: 15/857,210

(22) Filed: Dec. 28, 2017

(30) Foreign Application Priority Data
Mar. 15, 2017 (IN) 201741008901

(51) Int. Cl. G06F 13/10; H04L 29/06; G06F 13/42

(52) U.S. Cl. CPC G06F 13/102; G06F 2213/0042; G06F 13/4282; H04L 65/1069

(57) ABSTRACT

A media transfer method includes establishing a data connection between a mobile device and an accessory device such that the accessory device acts as a host configured to control access to first content stored within the accessory device. A a request for the first content is sent from the mobile device to the accessory device. In response to the request for the first content, the method includes sending, from the accessory device, the first content to the mobile device via the data connection, wherein first content is sent as a first transaction comprising a single header and a plurality of headerless data packets.

### CROSS-REFERENCE TO RELATED APPLICATIONS

The present application claims priority to Indian Provisional Patent Application No. 201741008901, filed Mar. 15, 2017, the contents of which are hereby incorporated by reference.

### TECHNICAL FIELD

The following discussion generally relates to data communication systems. More particularly, the following discussion relates to improved systems, methods, and protocols for data communication between mobile devices and corresponding accessory devices.

### BACKGROUND

Recent years have seen an increase in the use of smartphone, tablets, and other such mobile devices. Likewise, accessories for such devices have also become more popular.

It is often desirable for accessories to allow the transfer of content—such as movies, photos, and the like—to and from the mobile device to which it is connected. Such transfers often take place via a universal serial bus (USB) or other wired protocols. For example, one such protocol (the “Android Open Accessory” or “AOA” protocol) allows a USB accessory to wait for and detect a connected device, determine whether the device has accessory mode support, attempt to start the device in accessory mode, and, if possible, establish a communication with the device. In this way, the accessory device itself is able to select which data and/or functionality that can be accessed by the mobile device. This is particularly important in contexts where, for example, proprietary, encrypted, and/or copy-protected content (such as movie and television content) is streamed from an accessory device to the mobile device. AOA also facilitates role-reversal, wherein the accessory is the ‘master’ and the mobile device is the ‘slave.’ The mobile device in such cases no longer needs to power the accessory.

This and other known protocols are unsatisfactory, however, in that their payload transfer size (per packet) is usually limited. With respect to the AOA protocol, for example, packets are limited to 16 KB, with each packet having its own corresponding header. It will be appreciated that requiring a header for each packet tends to consume a significant portion of the bandwidth used for a given transaction (which might require transfer of a large number of individual packets).

It is therefore desirable to create improved systems, devices, and protocols for providing data communication between mobile devices and their respective accessories. These and other desirable features and characteristics will become apparent from the subsequent detailed description and the appended claims, taken in conjunction with the accompanying drawings and this background section.

### BRIEF SUMMARY

A media transfer method in accordance with one embodiment includes: establishing a data connection between a mobile device and an accessory device, such that the accessory device acts as a host configured to control access to first content stored within the accessory device; sending a request for the first content from the mobile device to the accessory device; in response to the request for the first content, sending, from the accessory device, the first content to the mobile device via the data connection, wherein first content is sent as a first transaction comprising a single header and a plurality of headerless data packets.

A content storage device in accordance with one embodiment is configured to establish a data connection with a mobile device such that the content storage device acts as a host configured to control access to first content stored within the accessory device, receives a request for the first content from the mobile device to the accessory device, and in response to the request for the first content sends the first content to the mobile device via the data connection, wherein first content is sent as a first transaction comprising a single header and a plurality of headerless data packets.

### BRIEF DESCRIPTION OF THE DRAWING FIGURES

Example embodiments will hereinafter be described in conjunction with the following drawing figures, wherein like numerals denote like elements, and

FIG. 1 is a conceptual overview of a content transfer system in accordance with one embodiment ;

FIG. 2 is a conceptual illustration of datagrams in accordance with various embodiments;

FIG. 3 is a conceptual block diagram of an exemplary transaction and packet structure in accordance with various embodiments;

FIG. 4 is a flowchart illustrating a method in accordance with one embodiment; and

FIG. 5 is a conceptual block diagram illustrating an example receiver that might be used in the context of the present embodiments.

### DETAILED DESCRIPTION

In general, the subject matter described herein relates to improved systems and methods for transferring content between a mobile device and a connected accessory device wherein the accessory device controls access to the content, and transfer is accomplished using a separate header for each transaction (in response to a single request from the mobile device), rather than for each packet. In this way, by reducing the ratio of header to payload size over the course of a transaction, the streaming of media content and transfer of large images can be improved significantly. As will be detailed below, such a system provides distinct advantages in a variety of contexts. In that regard, the following detailed description of the invention is merely exemplary in nature and is not intended to limit the invention or the application and uses of the invention. Furthermore, there is no intention to be bound by any theory presented in the preceding background or the following detailed description.

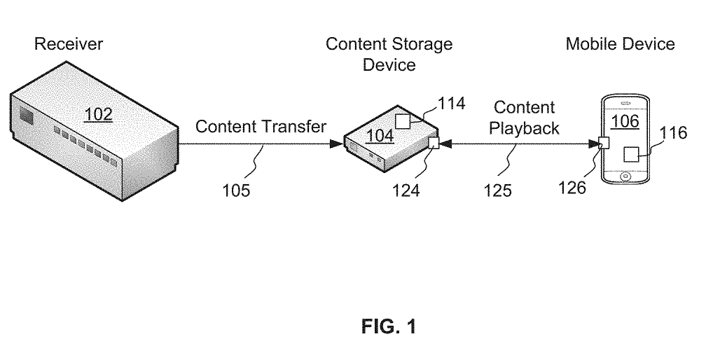

FIG. 1 is a conceptual overview of a content transfer system in accordance with one embodiment. As shown, a receiver 102 is communicative coupled (e.g., via any suitable wired or wireless connection 105) to an accessory device (e.g., a content storage device, or simply “device”) 104. Accessory device 104 may also be communicatively coupled to a mobile device 116 utilizing any suitable interconnection scheme and protocol 125. In that regard, mobile device 106 includes an interconnect interface 126, and likewise accessory device 104 includes an interconnect interface 124. In a particular, non-limiting example, interconnect 125 is a wired, USB interconnect and interfaces 124 and 126 are suitable USB connector assemblies (e.g., micro-USB, mini-USB, etc.).

Accessory device 104 includes a processing system 114, which might typically include, for example, one or more processors, storage devices, memory components, machine readable software, etc. Similarly, mobile device 106 includes a processing system 116 which, among other things, is configured to execute applications to achieve the various methods described herein.

Mobile device may correspond to a smartphone, a tablet device, a laptop, or any other such device now known or later developed. Accessory device 104 corresponds to any combination of hardware and software capable of implementing the target protocol, such as the AOA protocol described herein. For example, accessory device 104 may be a portable media storage device (e.g., the HOPPERGO device manufactured by Dish Network LLC). that allows video recordings (e.g., DVR recordings) to be stored and viewed at a later date.

With continued reference to the example shown in FIG. 1, one non-limiting use-case involving the transfer and subsequent streaming of media content (e.g., a movie or the like) will now be described. First, media content is transferred from receiver 102 to accessory device 104 through any suitable interconnect 105. For example, a single (possibly encrypted) video file may transferred to accessory device 104 using a wired or wireless communication protocol. Later (with accessory device 104 possibly disconnected from and remote from receiver 102), the user wishes to view the content on mobile device 106.

To accomplish this, mobile device 106 is connected via interconnect 125 to accessory device 104. As mentioned above, in one embodiment this connection is a suitable USB connection, as is known in the art. In particular, as discussed in further detail below, data communication takes place in accordance with a USB transfer protocol, such as the Android Open Accessory Protocol (“AOA protocol”), in which accessory device 104 operates in “host mode.” As used herein, the AOA protocol corresponds to the Android Open Accessory Protocol, version 1.0 and 2.0, which are hereby incorporated by reference.

As is known in the art, AOA allows external USB hardware (Android USB accessories) to interact with Android-powered devices in accessory mode. When an Android-powered powered device is in accessory mode, the connected accessory acts as the USB host (powers the bus and enumerates devices) and the Android-powered device acts as the USB accessory. AOA has two versions that support different types of communication. AOA v1 supports generic accessory communication and adb debugging. Available in Android 3.1 (API Level 12) and higher and supported through an Add-On Library in

Android 2.3.4 (API Level 10) and higher. AOAv2. Supports audio streaming and human interface device (HID) capabilities. Available in Android 4.1 (API Level 16).

The embodiments discussed herein are not so limited, however, and comprehend any subsequent version of AOA as well as, for example, any protocol that requires large files and/or streamed content to be transferred using a fixed packet length wherein each packet includes its own dedicated header. It also applies to protocols in which a single transaction (e.g., a response to a single request, such as the streaming of a single contiguous movie) is broken up into multiple, smaller packets, each having their own corresponding headers. The present embodiments have particular application to protocols in which the ratio of header size (aggregated over multiple packets) is relatively large compared to the payload size of each packet (as in the AOA protocol).

In order to address the limitations of the prior art, systems and methods in accordance with the present embodiment employ a single header for each transaction, rather than each packet, wherein “transaction” refers to fulfillment of a single request (e.g., a request to transfer a file, a request to stream media content, or the like).

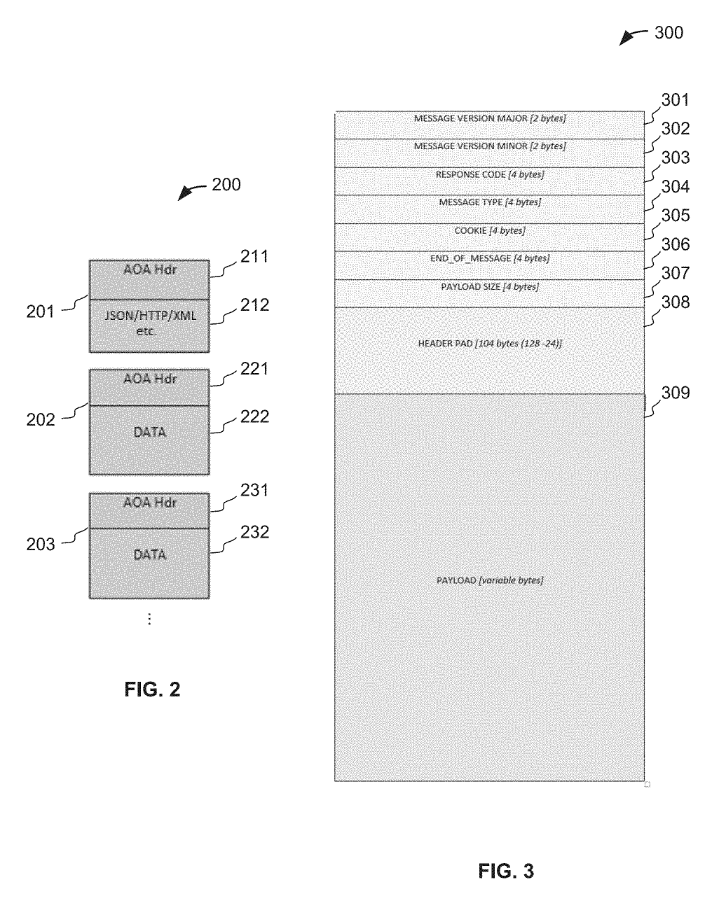

FIG. 2, for example, is a conceptual illustration 200 of datagrams in accordance with various embodiments. As shown, a number of transactions (201, 202, 203) each include a separate header (211, 221, and 231, respectively) corresponding to their respective payloads 212, 222, and 232. This is in contrast to host mode operation in typical AOA applications, in which each transaction (e.g., 201) is split up into many 16 KB packets, each having their own headers.

FIG. 3 is a conceptual block diagram of an exemplary transaction and packet structure in accordance with various embodiments. Specifically, transaction 300 includes a variety of parameters or fields 301-309 as illustrated, wherein parameters 301-308 correspond to the header, and parameter 309 corresponds to a (variable byte) payload. In accordance with one embodiment, the parameters have the following details:

| Name | Bytes | Description |
|---|---|---|
| message_version_major | 2 | Major version of the AoA message header. |
| message_version_minor | 2 | Minor version of the AoA message header. |
| Response_code | 4 | Contains the response code to a message. |
| | | Set to 0 for a request. |
| message_type | 4 | Indicates the type of message sent over the USB interface: |
| | | 0-Invalid |
| | | 1-Binary data (transfer of files) |
| | | 2-JSON data (getting/setting of configuration) |
| | | 3-XML |
| | | 4-HTTP |
| Cookie | 4 | Unique ID associated with a message. |
| | | Incremented per unique message sent. |
| | | Should match the request. |
| end of message | 4 | Set on the last packet of the given message. |
| | | Post this parameter getting set, message ID will increment. |
| Payload size | 4 | Data size. This indicates the size of the Message. |
| Pad | 128 − 24 = | PAD added (optional). |
| | 104 | In some embodiments, add MAC (message authentication |
| | | code) here. |
| Payload | Variable | Data sent to/from accessory device and mobile device. |
| | | In binary format. |

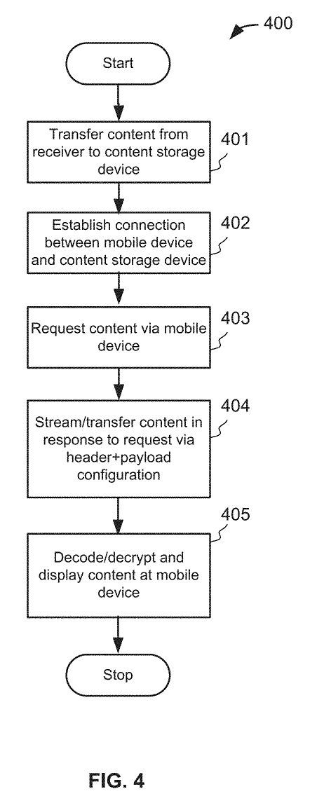

FIG. 4 is a flowchart illustrating a method in accordance with one embodiment. As shown, the process 400 begins at 401, wherein content is transferred from one device (e.g., receiver 102) to the content storage device (or accessory device) 104. Subsequently, a connection is established between mobile device 106 and content storage device 104 (step 402). As discussed previously, this step may be accomplished using the AOA protocol detailed above. At this point, the user requests content (e.g., requests to stream a movie stored within the content storage device) using a suitable user interface implemented by mobile device 106 (step 403). Next, content is streamed or otherwise transferred in response to the request, using the header/payload structure detailed above and shown in FIG. 3. This transfer/streaming process constitutes a single “transaction” that has its own header and a number of packets (e.g., 16 KB packets) used for the actual payload (step 404). The packets (except the first packet) are headerless. In step 405, the transferred/streamed content may be decoded and/or decrypted by the mobile device 106 (e.g., through a dedicated application stored within mobile device 106). In this way, encrypted and encoded content may be securely transferred from receiver 102 to accessory device 104 such that it can be viewed later on mobile device 106.

The protocols described above may be defined such that the primary message is transmitted seamlessly without any need for format conversion. This results in minimal to no change at both transmitter and receiver, merely an additional layer to understand the protocol. This enables the protocol to work irrespective of whether the payload is JSON/HTTP/XML, etc.

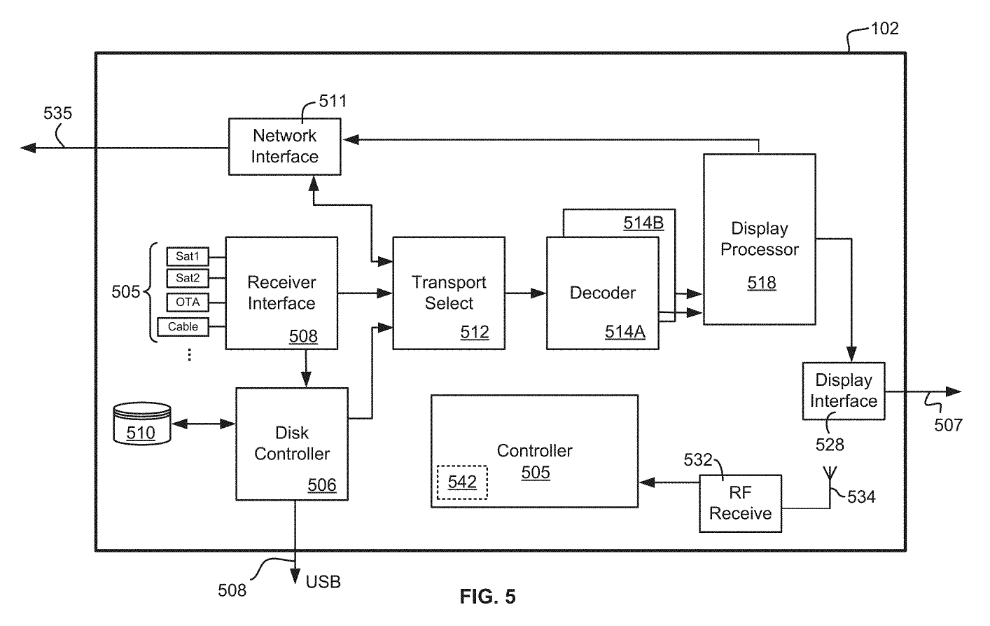

FIG. 5 is a conceptual block diagram illustrating an example receiver that might be used in the context of the present embodiments. It will be understood that this receiver is only shown as one example, and is not intended to be limiting. In general, a receiver 102 includes a receiver interface 508, a decoder 514 and a display processor 518. Receiver 102 also includes a disk controller interface 506 corresponding to a disk or other storage device 510, an interface 511 to a local or wide area network, a transport select module 512, a display interface 528, an RF receiver module and control logic 505. Other embodiments may incorporate additional or alternate processing modules from those shown in FIG. 5, may omit one or more modules shown in FIG. 5, and/or may differently organize the various modules in any other manner different from the exemplary arrangement shown in FIG. 5.

Receiver 102 may be physically and logically implemented in any manner. FIG. 5 shows various logical and functional features that may be present in an exemplary device; each module shown in the figure may be implemented with any sort of hardware, software, firmware and/or the like. Any of the various modules may be implemented with any form of general or special purpose integrated circuitry, for example, such as any sort of microprocessor, microcontroller, digital signal processor, programmed array and/or the like. Any number of the modules shown in FIG. 5, for example, may be implemented as a “system on a chip” (SoC) using any suitable processing circuitry under control of any appropriate control logic 505. In various embodiments, control logic 505 executes within an integrated SoC or other processor that implements receiver interface 508, transport selector 512, decoder(s) 514 (e.g., 514A and 514B), display processor 518, disk controller 506 and/or other features, as appropriate. The Broadcom Corporation of Irvine, Calif., for example, produces several models of processors (e.g., the model BCM 7400 family of processors) that are capable of supporting SoC implementations of satellite and/or cable receiver systems, although products from any number of other suppliers could be equivalently used. In still other embodiments, various distinct chips, circuits or components may be inter-connected and inter-relate with each other to implement the receiving and decoding functions represented in FIG. 5.

Various embodiments of receiver 102 may therefore include any number of appropriate modules for obtaining and processing media content as desired for the particular embodiment. Each of these modules may be implemented in any combination of hardware and/or software using logic executed within any number of semiconductor chips or other processing logic.

Various embodiments of control logic 505 can include any circuitry, components, hardware, software and/or firmware logic capable of controlling the various components of receiver 102. Various routines, methods and processes executed within receiver 102 are typically carried out under control of control logic 505 and stored as software instructions 542, as described more fully below. Generally speaking, control logic 505 receives user input signals via an RF receiver interface 532 that is able to communicate with a remote control using a suitable antenna or other interface. Control logic receives user inputs from the remote control and/or any other source, and directs the other components of receiver 102 in response to the received inputs to present the desired imagery (from multiple channels simultaneously) on a display.

As noted above, receiver 102 suitably includes a receiver interface 508, which includes any hardware, software, firmware and/or other logic capable of receiving media content via one or more content sources. In various embodiments, content sources may include cable television, DBS, broadcast and/or other programming sources as appropriate. Receiver interface 508 appropriately selects a desired input source and provides the received content to an appropriate destination for further processing. In various embodiments, received programming may be provided in real-time (or near real-time) to a transport stream select module 512 or other component for immediate decoding and presentation to the user. Alternatively, receiver interface 508 may provide content received from any source to a disk or other storage medium in embodiments that provide DVR functionality. In such embodiments, receiver 102 may also include a disk controller module 506 that interacts with an internal or external hard disk, memory and/or other device that stores content in a database 510, as described above.

In the embodiment shown in FIG. 5, receiver 102 also includes an appropriate network interface 511, which operates using any implementation of protocols or other features to support communication by receiver 102 on any sort of local area, wide area, telephone and/or other network. In various embodiments, network interface 511 supports conventional LAN, WAN or other protocols (e.g., the TCP/IP or UDP/IP suite of protocols widely used on the Internet) to allow receiver 102 to communicate on the Internet or any other network as desired. Network interface 511 typically interfaces with the network using any sort of LAN adapter hardware, such as a conventional network interface card (NIC) or the like provided within receiver 102. The output of display processor 518 may be provided to network interface 511 to produce a signal 535 that can be viewed, for example, on a mobile device or another remote computing device (e.g., via placeshifting). Other embodiments may provide interfaces 511 to conventional telephone lines or other communications channels, or may omit network connectivity altogether.

Transport stream select module 512 is any hardware and/or software logic capable of selecting a desired media stream from the available sources. In the embodiment shown in FIG. 5, stream select module 512 is configured to generate video signals for presentation on one or more output interfaces 528. Typically, transport select module 512 responds to viewer inputs (e.g., via control logic 505) to simply switch encoded content received from a broadcast, satellite, cable or other source 105 or from storage 510 to one or more decoder modules 514.

Receiver 102 may include any number of decoder modules 514A-B for decoding, decompressing and/or otherwise processing received/stored content as desired. Generally speaking, decoder modules 514A-B decompress, decode and/or otherwise process received content from transport select module 512 to extract an MPEG or other media stream encoded within the stream. The decoded content can then be processed by one or more display processor modules 518 to create a presentation on a display for the viewer in any appropriate format. FIG. 5 shows two decoder modules 514 operating on television signals received from transport select module 512. In practice, any number of decoder modules 514 may be used, particularly in PIP settings where multiple signals are simultaneously decoded and displayed, or in embodiments wherein channel content is directly scrolled across other channel content. In such embodiments, it may be desirable to receive multiple channels simultaneously to facilitate the rapid scrolling of content on a common display of imagery. That is, by simultaneously tuning and decoding content from multiple channels, the scrolling from one channel to the next can be facilitated. Other embodiments, however, may not make use of multiple decoder modules 514, but may instead only decode a single stream at any particular time. The term “decoder”, then, may collectively apply to one or more decoder modules that are able to decode one or more signals for presentation on a display.

Display processor module 518 includes any appropriate hardware, software and/or other logic to create desired screen displays via display interface 528 as desired. Such displays may include combining signals received from one or more decoder modules 514 to facilitate viewing of one or more channels. In various embodiments, display processing module 518 is also able to produce on screen displays (OSDs) for electronic program guide, setup and control, input/output facilitation and/or other features that may vary from embodiment to embodiment. Such displays are not typically contained within the received or stored broadcast stream, but are nevertheless useful to users in interacting with receiver 102 or the like. The generated displays, including received/stored content and any other displays may then be presented to one or more output interfaces 528 in any desired format. The various interface features described herein, for example, may be generated by display processor module 218 operating alone or in conjunction with control logic 505.

Display processor 518 produces an output signal encoded in any standard format (e.g., ITU656 format for standard definition television signals or any format for high definition television signals) that can be readily converted to standard and/or high definition television signals at interface 528. In other embodiments, the functionality of display processor 518 and interface 528 may be combined in any manner.

The various processes, devices and systems described herein may be readily adapted for any number of equivalent environments and applications. The above examples are not meant to be limiting.

The term “exemplary” is used herein to represent one example, instance or illustration that may have any number of equivalent alternatives. Any implementation described herein as “exemplary” is not necessarily to be construed as preferred or advantageous over other implementations, but rather as a mere example. While several example embodiments have been presented in the foregoing detailed description, it should be appreciated that a vast number of alternate but equivalent variations exist, and the examples presented herein are not intended to limit the scope, applicability, or configuration of the invention in any way. To the contrary, various changes may be made in the function and arrangement of elements described without departing from the scope of the claims and their legal equivalents.

What is claimed is:

1. A media transfer method comprising:
establishing a data connection between a mobile device and an accessory device, such that the accessory device acts as a host configured to control access to first content stored within the accessory device;
sending a request for the first content from the mobile device to the accessory device;
in response to the request for the first content, sending, from the accessory device, the first content to the mobile device via the data connection, wherein first content is sent as a first transaction comprising a single header and a plurality of headerless data packets.

2. The method of claim 1, wherein the data connection is a USB data connection.

3. The method of claim 2, wherein the data connection is established in accordance with an Android Open Accessory protocol.

4. The method of claim 3, wherein the first connection includes a variable length payload and a fixed header size.

5. The method of claim 1, wherein the first content is encoded, and the mobile device includes a processing system configured to decode the first content prior to displaying the first content.

6. A content storage device configured to establish a data connection with a mobile device such that the content storage device acts as a host configured to control access to first content stored within the content storage device, receives a request for the first content from the mobile device to the content storage device, and in response to the request for the first content sends the first content to the mobile device via the data connection, wherein first content is sent as a first transaction comprising a single header and a plurality of headerless data packets.

7. The content storage device of claim 6, wherein the data connection is a USB data connection.

8. The content storage device of claim 7, wherein the data connection is established in accordance with an Android Open Accessory protocol.

9. The content storage device of claim 8, wherein the first connection includes a variable length payload and a fixed header size.

10. The content storage device of claim 6, wherein the first content is encoded, and the mobile device includes a processing system configured to decode the first content prior to displaying the first content.

11. A system for media transfer comprising:
A mobile device;
An accessory device configured to establish a data connection with the mobile device and control access to first content stored within the accessory device, the accessory device further configured to receive a request for the first content from the mobile device, and in response to the request send the first content to the mobile device via the data connection, wherein first content is sent as a first transaction comprising a single header and a plurality of headerless data packets.

12. The system of claim 11, further including an entertainment device receiver configured to transfer the first content to the content storage device.

13. The content storage device of claim 6, wherein the data connection is a USB data connection.

14. The content storage device of claim 7, wherein the data connection is established in accordance with an Android Open Accessory protocol.

15. The content storage device of claim 8, wherein the first connection includes a variable length payload and a fixed header size.

16. The content storage device of claim 6, wherein the first content is encoded, and the mobile device includes a processing system configured to decode the first content prior to displaying the first content.
